(19) United States
(12) Patent Application Publication
(10) Pub. No.: US 2006/0135020 A1
(43) Pub. Date: Jun. 22, 2006

(54) Flash spun web containing sub-micron filaments and process for forming same

(76) Inventors: Mark Gary Weinberg, Wilmington, DE (US); Gregory T. Dee, Wilmington, DE (US); Thomas William Harding, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/015,527

(22) Filed: Dec. 17, 2004

(51) Int. Cl. B32B 3/00; B32B 3/26

(52) U.S. Cl. 442/340; 264/165; 428/903; 428/315.5; 264/405; 264/413; 264/449

(57) ABSTRACT

A nonwoven fibrous structure and process for forming it, which is an interconnecting web of polyolefin filaments having filament widths greater than about 1 micrometer which are further interconnected with webs of smaller polyolefin filaments having filament widths less than about 1 micrometer, wherein the smaller polyolefin filaments comprise a majority of all filaments.

### BACKGROUND OF THE INVENTION

Because of its large volume and favorable economics, the protective apparel market is a highly desirable one for nonwoven structures. This market comprises protection from hazardous chemicals in such diverse areas as spill clean-up, medical uses, and paint and asbestos removal. It has been long known that for a garment to be comfortable, it must easily allow the body to transfer heat and moisture to the environment. This goal is achieved when the garment is made with fabrics having low air flow resistance. At the same time, the garment needs to provide protection from the expected hazards. The degree of protection is dependent upon the effectiveness of the barrier characteristics of the fabric. The barrier characteristics have been correlated with fabric pore size, with the smallest pore size providing the most effective barrier properties. Unfortunately, smaller pore size also generally results in higher air flow resistance and a less comfortable garment. Thus, there is a need to provide a material that offers a more favorable balance between barrier and air flow than existing fabrics. Such a material would minimize discomfort, limitations on activity, and in the extreme, heat stress, while still offering adequate protection.

Porous sheet materials are also used in the filtration of gases where the filtration materials are used to remove dirt, dust and particulates from a gas stream. For example, air filters and vacuum cleaner bags are designed to capture dirt, dust and fine particulates, while at the same time allowing air to pass through the filter. Porous sheet materials are also used in applications where it is necessary to filter out microbes such as spores and bacteria. For example, porous sheet materials are used in the packaging of sterile medical items, such as surgical instruments. In sterile packaging, the porous packaging material must be porous to gases such as ethylene oxide that are used to kill bacteria on items being sterilized, but the packaging materials must be impervious to bacteria that might contaminate sterilized items. Another application for porous sheet materials with good barrier properties is for making pouches that hold moisture absorbing desiccant substances. Such desiccant pouches are frequently used in packaged materials to absorb unwanted moisture.

Microporous films have been used to achieve extremely high liquid barrier properties. A microporous film is made of an interconnected network of micropores (i.e., on the order of micrometers in diameter), which by their tortuosity and size, provide a liquid barrier. However, this barrier is at the expense of breathability, rendering fabrics containing such films uncomfortable for the wearer. In addition, since the microporous film itself is usually not very durable or cloth-like, it is typically laminated to at least one nonwoven layer or preferably two layers, forming a sandwich with the film in the middle. This construction adds additional weight and expensive processing steps.

Another engineered multilayer laminate is known as SMS (spunbond-meltblown-spunbond). In typical SMS constructions for protective apparel, the outer spunbond layers are made of randomly deposited 15-20 micrometers diameter continuous polypropylene fibers which provide comfort, as well as protection for the meltblown layer. The inner meltblown layer provides the barrier properties and is typically comprised of 1-3 micrometers diameter polypropylene fibers. As with the microporous films, this construction adds additional weight for the garment's wearer and expensive process steps for the manufacturer.

Tyvek® spunbonded olefin is a flash-spun plexifilamentary sheet material that has been in use for a number of years as a material for protective apparel. E. I. du Pont de Nemours and Company (DuPont) makes and sells Tyvek® spunbonded olefin nonwoven fabric. Tyvek® is a trademark owned by DuPont. Tyvek® nonwoven fabric has been a good choice for protective apparel because of its excellent strength properties, its good barrier properties, its light weight, its reasonable level of thermal comfort, and its single layer structure that gives rise to a low manufacturing cost relative to most competitive materials. DuPont has worked to further improve the comfort of Tyvek® fabrics for garments.

The process for making flash-spun plexifilamentary sheets, and specifically Tyvek® spunbonded olefin sheet material, was first developed more than twenty-five years ago and put into commercial use by DuPont. U.S. Pat. No. 3,081,519 to Blades et al., describes a process wherein a solution of fiber-forming polymer in a liquid spin agent that is not a solvent for the polymer below the liquid's normal boiling point, at a temperature above the normal boiling point of the liquid, and at autogenous pressure or greater, is spun into a zone of lower temperature and substantially lower pressure to generate plexifilamentary film-fibril strands. As disclosed in U.S. Pat. No. 3,227,794 to Anderson et al., plexifilamentary film-fibril strands are best obtained using the process disclosed in Blades et al. when the pressure of the polymer and spin agent solution is reduced slightly in a letdown chamber just prior to flash-spinning.

Flash-spinning of polymers using the process of Blades et al. and Anderson et al. requires a spin agent that: (1) is a non-solvent to the polymer below the spin agent's normal boiling point; (2) forms a solution with the polymer at high pressure; (3) forms a desired two-phase dispersion with the polymer when the solution pressure is reduced slightly in a letdown chamber; and (4) flash vaporizes when released from the letdown chamber into a zone of substantially lower pressure. Depending on the particular polymer employed, the following compounds have been found to be useful as spin agents in the flash-spinning process: aromatic hydrocarbons such as benzene and toluene; aliphatic hydrocarbons such as butane, pentane, hexane, heptane, octane, and their isomers and homologs; alicyclic hydrocarbons such as cyclohexane; unsaturated hydrocarbons; halogenated hydrocarbons such as trichlorofluoromethane, methylene chloride, carbon tetrachloride, dichloroethylene, chloroform, ethyl chloride, methyl chloride; alcohols; esters; ethers; ketones; nitrites; amides; fluorocarbons; sulfur dioxide; carbon dioxide; carbon disulfide; nitromethane; water; and mixtures of the above liquids. Various solvent mixtures useful in flash-spinning are disclosed in U.S. Pat. No. 5,032,326 to Shin; U.S. Pat. No. 5,147,586 to Shin et al.; and U.S. Pat. No. 5,250,237 to Shin.

U.S. patent application Ser. No. 09/691,273, filed Oct. 18, 2000, now allowed, discloses recent improvements to flash spun plexifilamentary polyolefins and a process for producing them and is hereby incorporated by reference in its entirety.

However, the flash spinning processes developed to date do not produce fibrous webs having significant quantities of sub-micron filaments.

Recently efforts have been directed to producing “nanofibers”, those with diameters in the “nano” size range, functionally defined as less than about 1 micrometer, preferably below about 0.5 micrometer (i.e., 500 nanometers). This significantly lower fiber diameter and the concomitant decrease in average pore size lead to significantly different sheet properties, such as fiber surface area, basis weight, strength, barrier, and permeability. The lower fiber diameters are expected to lead to an improved barrier/permeability balance and enhanced comfort. However, like the other laminated structures, nanofibers typically need supporting layers.

Nanofibers have conventionally been produced by the technique of electrospinning, as described in “Electrostatic Spinning of Acrylic Microfibers”, P. K. Baumgarten, Journal of Colloid and Interface Science, Vol. 36, No. 1, May 1971. In this process, an electrical potential is applied to a drop of polymer in solution hanging from a metal tube, such as a syringe needle. The electric field produced between the electrode and grounded collector results in extension of the droplet to produce very fine fibers on the collector. Fibers with diameters in the range of 0.05 to 1.1 micrometer (50 to 1100 nm) are reported. A major problem with this technique is low flow rate, on the order of 0.1 gram of polymer solution/minute/hole, far too low for industrial applications. This limitation is due to the coupling of the electric field and the flow rate.

There are two other limitations of classical electrospinning technology that involve the nature of the polymer. The first is surface wetting. The wetting of the sheet surface by specific liquids is important because the barrier properties of protective fabrics are proportional to the contact angle between the liquid and the surface, with the contact angle defined as the angle of intersection between the fluid and solid surfaces. Barrier properties increase with increasing contact angle (i.e., decreased wetting). The vast majority of the work reported in the prior art has been directed towards the electrospinning of hydrophilic polymers, such as polyamides, polyolefin oxides, and polyurethanes, that are readily wet by aqueous systems, like blood. While some investigators have suggested that nanofibers could be produced from hydrophobic polymers that would have improved barrier to aqueous systems, few real examples exist. U.S. Pat. No. 4,127,706 discloses the production of porous fluoropolymer fibrous sheet and suggests the production of polytetrafluoroethylene fibers with diameters in the range of 0.1 to 10 microns. Nonetheless, the patent only exemplifies fibers with diameters of 0.5 micron and above.

The second polymer-based limitation of classical electrospinning involves polymer solubility in the solvent. The vast majority of the work reported in the prior art involves polymers that are either soluble or capable of being made into a dispersion at room temperature and atmospheric pressure. This apparent requirement severely limits the polymers suitable for being spun into nanofibers.

It would be desirable to produce barrier fabrics having good air and moisture permeability, while retaining good resistance to liquid penetration.

### BRIEF SUMMARY OF THE INVENTION

A first embodiment of the present invention is a nonwoven fibrous structure comprising an interconnecting web of polyolefin filaments having filament widths greater than about 1 micrometer which are further interconnected with webs of smaller polyolefin filaments having filament widths less than about 1 micrometer, wherein said smaller polyolefin filaments comprise a majority of all filaments.

A second embodiment of the present invention is a nonwoven fibrous structure comprising a collection of filaments formed from a polyolefin composition wherein the mean of the filament widths is less than about 1 micrometer and the maximum of the filament widths is greater than about 1 micrometer.

A third embodiment of the present invention is a nonwoven fibrous structure comprising a collection of filaments formed from a polyolefin composition comprising a collection of polyolefin filaments wherein the mean of the filament widths is less than about 1 micrometer, and pores formed between said polyolefin filaments, said nonwoven fibrous structure exhibiting a pore size diameter equivalent distribution of between about 0.20 to about 2.5 micrometers.

Another embodiment of the present invention is a method of producing a nonwoven fibrous structure having a majority of filaments with filament widths less than about 1 micrometer, comprising supplying a polyolefin solution at above-ambient temperature and pressure to a spinneret, contacting said polyolefin solution with a first electrode disposed within said spinneret, said electrode being charged to a high voltage potential relative to a collection surface, so as to impart an electric charge to said polyolefin solution, issuing said charged polyolefin solution through a spinneret exit orifice which incorporates a second electrode held at less than the voltage potential of said first electrode, to form polyolefin filaments, and collecting said polyolefin filaments on said collection surface to form an interconnecting web of polyolefin filaments having filament widths greater than about 1 micrometer which are further interconnected with webs of smaller polyolefin filaments having filament widths less than about 1 micrometer, wherein said smaller polyolefin filaments comprise a majority of all filaments.

### BRIEF DESCRIPTION OF THE DRAWINGS

FIG. 1 is a schematic representation of a prior art electrospinning apparatus as described in U.S. Pat. No. 4,127,706.

FIG. 2 is a schematic representation of another prior art electrospinning apparatus as described in U.S. Published Patent Application No. 2003/0106294 A1.

FIG. 3 is a schematic representation of an electrospinning apparatus used to conduct the process of the present invention.

FIG. 4 is a scanning electron microscope (SEM) image of a prior art commercial nanofiber-containing filter media.

FIG. 5 is a SEM image taken at 4000× of a portion of a plexifilamentary fiber strand from a prior art conventional flash-spun plexifilamentary sheet material.

FIG. 6 is a SEM image taken at 5000× of a portion of a plexifilamentary fiber strand from the prior art plexifilamentary sheet material made according to the process disclosed in U.S. Ser. No. 09/691,273.

FIG. 7 is a SEM image of the product of Comparative Example 1 at a magnification of 100×.

FIG. 8 is a SEM image of the product of Example 1 at a magnification of 150×.

FIG. 9 is a SEM image of the product of Example 1 at a magnification of 2500×.

FIG. 10 is a SEM image of the product of Example 2 at a magnification of 1500×.

FIG. 11 is a SEM image of the product of Example 3 at a magnification of 150×.

FIG. 12 is a SEM image of the product of Example 4 at a magnification of 1000×.

FIG. 13 is a SEM image of the product of Example 5 at a magnification of 5000×.

FIG. 14 is a SEM image of the product of Example 6 at a magnification of 5000×.

FIG. 15 is a SEM image of the product of Example 7 at a magnification of 3000×.

FIG. 16 is a SEM image of the product of Example 8 at a magnification of 1000×.

FIG. 17 is a SEM image of the product of Example 9 at a magnification of 1000×.

FIG. 18 is a SEM image of the product of Example 10 at a magnification of 3000×.

FIG. 19 is a SEM image of the product of Example 11 at a magnification of 3000×.

FIG. 20 is a SEM image of the product of Example 12 at a magnification of 3000×.

FIG. 21 is a SEM image of the product of Example 13 at a magnification of 3000×.

FIG. 22 is a SEM image of the product of Example 14 at a magnification of 10,000×.

FIG. 23 is a SEM image of the product of Example 15 at a magnification of 10,000×.

FIG. 24 is a SEM image of the product of Example 16 at a magnification of 1000×.

FIG. 25 is a SEM image of the product of Example 17 at a magnification of 1000×.

### DETAILED DESCRIPTION OF THE INVENTION

Unlike in conventional electrospinning, the polymer solutions in the instant invention are made and spun under flash-spinning conditions; i.e., at elevated temperatures and pressures greater than autogenous at the solution boiling point. Significantly, the present invention is advantageously applicable to polymer materials that are soluble only at elevated temperatures and pressures. Thus, nanofibers from difficult-to-dissolve polymers such as polyolefins have been produced for the first time at relatively high rates of production. These polymers are hydrophobic and offer the potential of products with substantially different wetting characteristics and barrier properties compared to the usual hydrophilic polymers typically electrospun by the classical process.

The process steps described herein can lead to nonwoven fibrous webs having a significantly different morphology than those produced by other technologies. As used herein, the terms “filaments” and “fibers” and their derivatives (such as “nanofibers”) are intended as equivalents and no distinction as to their meanings should be implied.

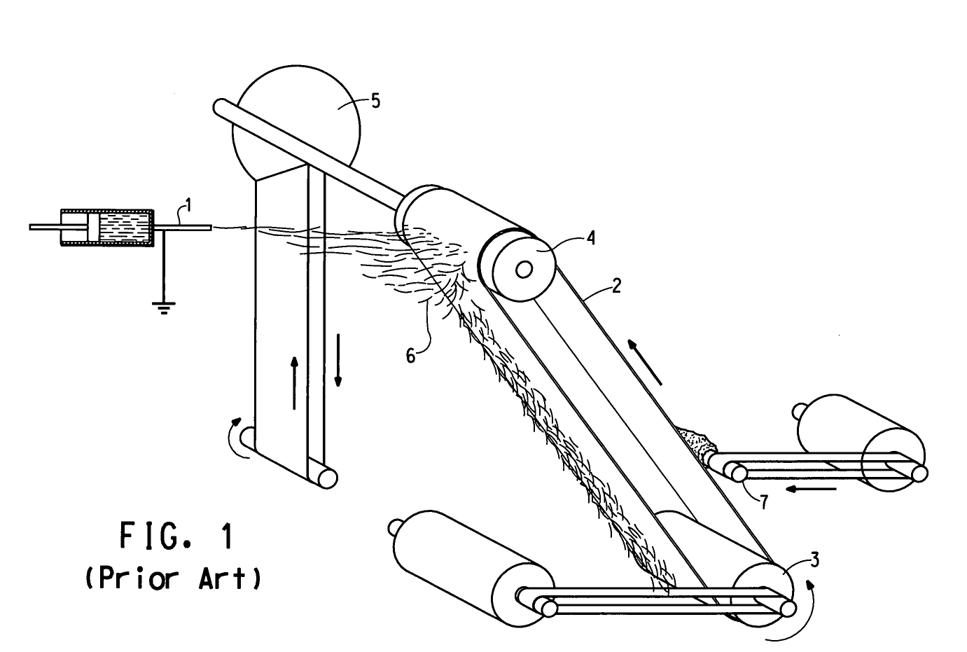

In classical electrospinning, the fiber morphology has the “appearance of smooth, straight cylinders” (Baumgarten, cited above). FIG. 1 is a schematic representation of a classical electrospinning apparatus as disclosed in U.S. Pat. No. 4,127,706, wherein a grounded metal syringe needle 1 is supplied with a spinning liquid from a reservoir (not shown) to form polytetrafluoroethylene nanofibers, which are deposited on belt 2 driven by a driving roller 3 and an idler roller 4, to which is fed an electrostatic charge from a generator 5, thus forming a nanofiber mat 6 which is picked up by a roller 7 rotating against the belt.

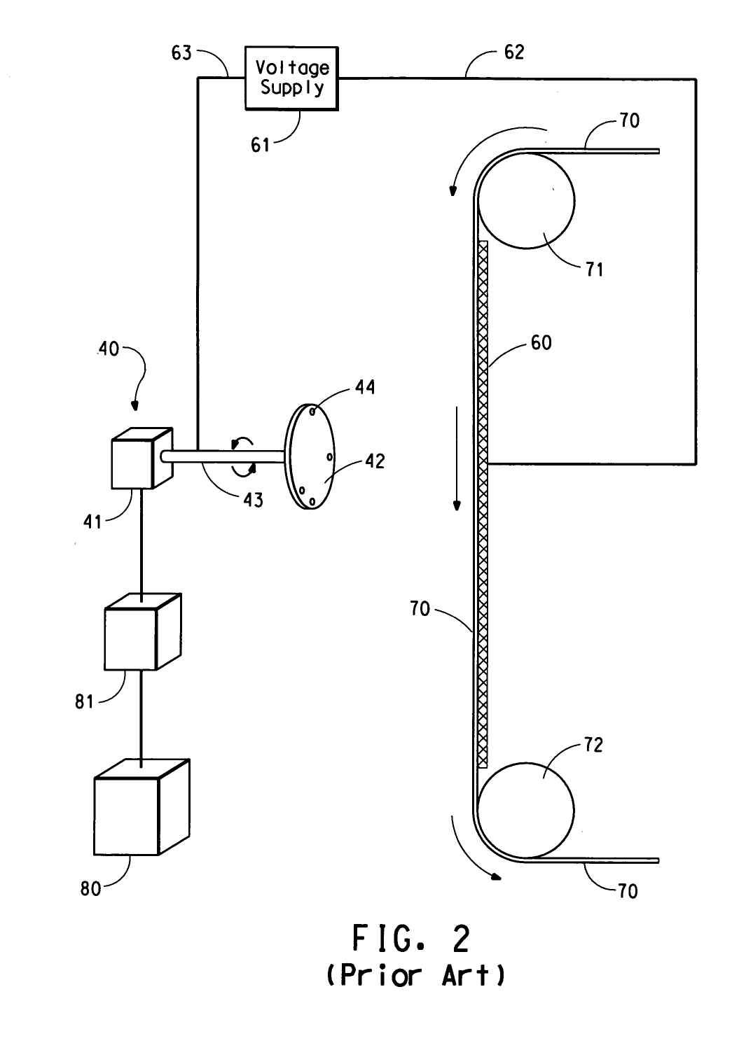

FIG. 2 discloses an alternative electrospinning device as described in U.S. Published Patent Application No. 2003/0106294 A1, wherein a reservoir 80 is provided, in which a fine fiber forming polymer solution is contained, a pump 81 and a rotary-type emitting device or emitter 40 to which the polymeric solution is pumped. The emitter 40 generally consists of a rotating union 41, a rotating portion 42 including a plurality of offset holes 44 and a shaft 43 connecting the forward facing portion and the rotating union. The rotating union 41 provides for introduction of the polymer solution to the forward facing portion 42 through the hollow shaft 43. The holes 44 are spaced around the periphery of the forward facing portion 42. The rotating portion 42 then obtains polymer solution from the reservoir and as it rotates in the electrostatic field, a droplet of the solution is accelerated by the electrostatic field toward the collecting media 70. Facing the emitter 40, but spaced apart therefrom, is a substantially planar grid 60 upon which the collecting media 70 (i.e. substrate or combined substrate) is positioned. Air can be drawn through the grid. The collecting media 70 is passed around rollers 71 and 72 which are positioned adjacent opposite ends of grid 60. A high voltage electrostatic potential is maintained between emitter 40 and grid 60 by means of a suitable electrostatic voltage source 61 and connections 62 and 63 which connect respectively to the grid 60 and emitter 40.

U.S. Published Patent Application No. 2003/0106294 A1 suggests that the apparatus can be used for forming nanofibers from a variety of different polymers, but exemplifies only polyamide-based nanofibers.

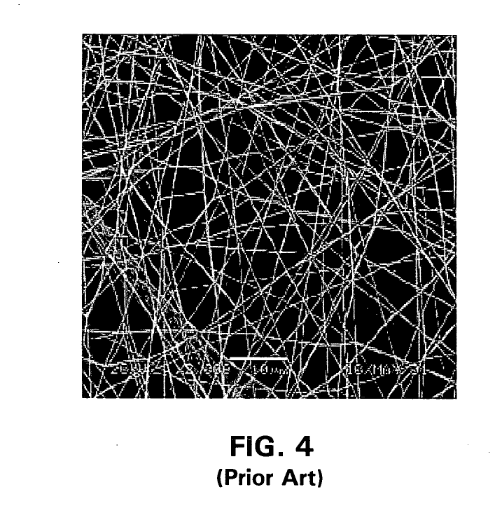

FIG. 4 is a scanning electron micrograph of a commercial filter media containing conventionally electrospun fibers produced by the Donaldson Company (Timothy H. Grafe and Kristine M. Graham in “Nanofiber Webs from Electrospinning”, presented at the Nonwovens in Filtration Meeting-Fifth International Conference, Stuttgart, Germany, March, 2003), which is believed to have been produced by the apparatus described in FIG. 2 hereof. In particular, the image shows nanofibers electrospun onto a cellulose substrate for air filtration applications. The nanofiber diameter is approximately 250 nanometers, vs. the supporting cellulosic fiber structure with diameters exceeding 10 microns.

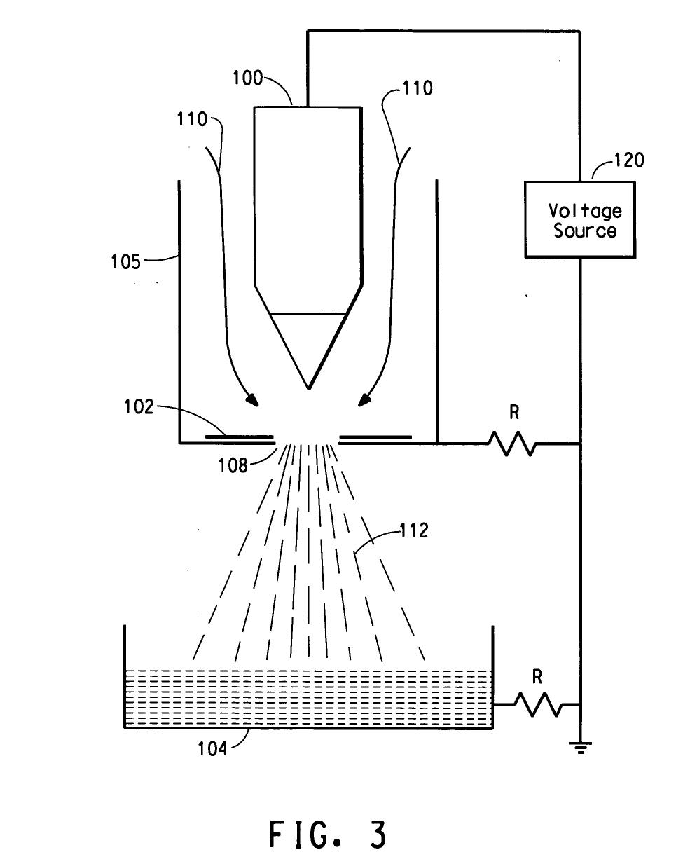

FIG. 3 is a schematic representation of the electrospinning apparatus used to form the novel polyolefin structures of the present invention. A first (emitter) electrode 100, which is charged to a high voltage potential by voltage source 120, is disposed within a spinneret 105 made of a conductive material, such as a metal, and in contact with a high pressure, high temperature polyolefin solution stream 110 which is provided by a storage vessel (not shown). The polyolefin solution stream flows past the emitter electrode 100 and has an electrical charge injected therein, then flows past a second (blunt) electrode 102 which is electrically connected to ground through a resistor. Downstream of the second electrode 102 the charged polyolefin solution stream flows through a spinneret exit orifice 108 at which point the solvent portion of the solution is flash evaporated, and due to the electrical charge imparted to the polyolefin solution, flash spun polyolefin filaments or fibers 112 having unusually small widths are formed, which are in turn deposited on grounded collector electrode 104. The second electrode and the collector electrode do not necessarily need to be connected to ground, but can be electrically maintained at potential differences from the first electrode. The charge-injection apparatus illustrated in FIG. 3 is similar to that described in U.S. Pat. No. 6,656,394, which is incorporated herein by reference.

The product morphology produced by the present invention can be generally characterized as plexifilamentary. As described in Kirk-Othmer Encyclopedia of Chemical Technology, (Fourth Edition, volume 17, pages 353-355), the term “plexifilamentary yarn” refers to a yarn or strand characterized by a morphology substantially consisting of a three-dimensional integral network of thin, ribbon-like, film-fibril elements of random length that have a mean film thickness of less than about 4 microns and a median fibril width of less than 25 microns, and that are generally coextensively aligned with the longitudinal axis of the yarn. In plexifilamentary yarns, the film-fibril elements intermittently unite and separate at irregular intervals in various places throughout the length, width and thickness of the yarn, thereby forming the three-dimensional network. Plexifilamentary yarns of this type have found widespread commercial value primarily in the form of flash-spun high density polyethylene non-woven fabrics, most notably Tyvek® non-woven fabric, which is manufactured by the E.I. du Pont de Nemours and Company of Wilmington, Del. Conventional plexifilamentary yarns have much larger dimensions than those exemplified in the instant application.

As illustrated in FIGS. 8-10 and 12-25, the products formed according to the presently disclosed process are complex interconnecting networks or “webs” of larger polyolefin filaments or fibers which are themselves further interconnected by webs of smaller polyolefin filaments or fibers. The “webs” of the present invention are similar in structure to spider webs, but are irregular both in filament size and the location of intersection points. The larger filaments generally have widths of greater than about 1 micrometer and the smaller filaments generally have widths of less than about 1 micrometer. Importantly, the majority (by number) of all filaments in the inventive nonwoven fibrous structures are the smaller, sub-micron filaments.

The smaller filaments have widths ranging from 0.01 micrometer up to about 1 micrometer, with substantial numbers of small filaments having widths from about 0.1 to about 0.8 micrometer, and many having widths below about 0.5 micrometer.

The filaments of the nonwoven structures of the present invention display filament or fiber width distributions with mean widths between about 0.18 and about 1 micrometer, even between about 0.18 and about 0.7 micrometer, or even as low as between about 0.18 to about 0.5 micrometer.

Another salient feature of the nonwoven structures of the present invention are the minute void or pore sizes which are present between the intersecting points of the filaments. The mean pore size distributions range between about 0.20 to about 2.5 micrometers, measured as diameter equivalents, discussed below.

Another important characteristic of the nonwoven polyolefin structures of the present invention, evident from the SEM images in the Figures of the present invention, is that the lengths of the submicron fibers or filaments are on the same order of magnitude as the diameters of the voids or pores, and the mathematical mean of the unsupported submicron fiber or filament lengths is generally about 10 micrometers or less, even less than about 5 micrometers, and in some instances less than about 3 micrometers, which is distinctly different from conventional nanofibers, as depicted in FIG. 4, wherein the lengths of the nanofibers greatly exceed the approximate sizes of the pores between them.

An important aspect of the present invention is the high polymer throughput achievable through the use of the charge injection apparatus of FIG. 3. It offers the potential of at least two orders-of-magnitude higher polymer solution flowrates than those obtainable with conventional electrospinning apparatuses. The first (i.e., emitter) and second (i.e., blunt) electrodes form an electron gun that is immersed in the fluid. The distance between the electrodes is advantageously only about one spinneret orifice diameter, providing a very large electric field and one that is much larger than that provided in classical electrospinning. Thus, a high rate of charge injection is possible in low conductivity fluids, which results in a high density of the charge in the fluid. Additionally, this charge stays in the solution because of the very short residence time prior to the solution exiting from the orifice. These attributes result in a decoupling of the solution flow rate and charge injection processes, enabling nanofiber spinning at polymer solution flow rates between about 1 to about 20 cm³/sec or higher, preferably between about 2 to about 15 cm³/sec, more preferably between about 2.5 to about 12 cm³/sec.

While the examples below demonstrate polymer/solvent combinations that are in a single-phase solution at the spinning conditions, this invention is not so limited. Two-phase solutions (i.e., those with a polymer-rich and a solvent-rich phase) are also useful in the presently disclosed process.

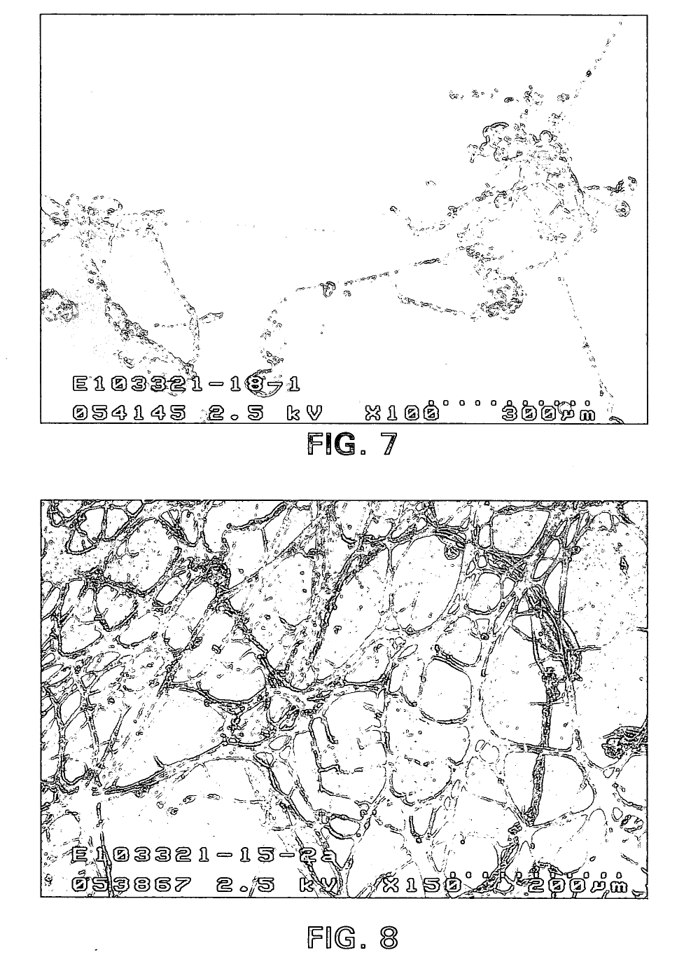

There are many process parameters that appear to influence the product produced by the process of this invention. The first electrode voltage (relative to the second electrode) is advantageously greater than or equal to about 3 kV, up to as high as about 17 kV, preferably between about 11 kV and about 16.4 kV. In the absence of a voltage applied to the electrode to provide an electric charge, no nanofibers are produced (FIG. 7). An improved morphology in which the number of nanofibers is large and their size is small, is believed to be offered by a higher electric charge density in the polymer solution. Charge density is defined as the net electric current added to the solution divided by the solution flow rate. If the collection device is a good Faraday cage (i.e., made from metal), the net current added to the solution can be determined from a direct reading of the current from the Faraday device, read either from a hard-wired current meter or by a computer that reads the voltage across a resistor installed between the Faraday cage and ground. If the collection device is a poor Faraday cage (i.e., made from a non-conductor or some combination of non-conductive and conductive elements), the net current added to the solution can be determined from the difference between the measured first electrode high voltage supply current and the second electrode current. The upper charge density limit is determined when the injected charge is sufficiently high that its electric field breaks down the gas blanketing the solution column exiting the spinneret. If all other conditions are held constant, the maximum achievable charge density generally decreases with increasing orifice diameter. A typical charge density is about 1 microCoulomb/mL of polymer solution for a 0.25 mm diameter orifice, and is preferably between about 0.4 to about 3 microCoulomb/mL.

Another important process parameter is selection of the polymer solution. The present process is advantageous in the spinning of addition polymers in low conductivity solvents. Among addition polymers, the polyhydrocarbons, polyethylene and polypropylene (PP), and ethylene-C₃ to C₁₀ α-olefin copolymers, such as ethylene-octene copolymers, ethylene-propylene copolymers and ethylene-butene copolymers are preferred. All types of polyethylene are included, such as high density linear polyethylene (HDPE), low density polyethylene (LDPE) and linear low density polyethylene (LLDPE). Other addition polymers that could be used include polymethylpentene and propylene-ethylene copolymers. Polyolefins suitable for use are characterized by a melt flow index (MFI) of about 0.1 to about 1000 g/10 minute, as measured according to ASTM D-1238E, with a melt flow index of about 1 to about 30 g/l 0 minute preferred.

Suitable solvents should (a) have a boiling point at least about 25° C. and preferably at least about 40° C. below the melting point of the polymer used; (b) be substantially unreactive with the polymer during mixing and spinning; (c) dissolve the polymer under the conditions of temperature, concentration and pressure used in the process; and (d) have an electrical conductivity less than about 10⁶ pS/m (picoSiemens/meter). More preferred solvents have electrical conductivities less than about 10⁵ pS/m. Especially preferred solvents should have electrical conductivities less than about 10² pS/m. Suitable solvents, depending upon the polymer, include, but are not limited to, Freon®-11, the alkanes pentane, hexane, heptane, octane, nonane, and their mixtures. The polyolefin solution should have a low enough conductivity to maintain without arcing the potential voltage difference between the first electrode and the second electrode while the polymer solution is flowing.

There are a wide range of solution viscosities under which the process of the present invention can be conducted. While there are no absolute solution viscosity measurements to quantify this range, we have found that suitable operating conditions can be obtained by balancing solution polymer concentration and polymer molecular weight. An inverse measure of the polymer molecular weight is given by the polymer melt flow index, as measured by ASTM D-1238 at 190° C. and 2.16 kg. A higher melt flow index indicates a lower polymer molecular weight. For example, nanofibers were easily produced with ethylene-octene copolymer of MFI 30 at a concentration of 3 wt. % in the solution. An almost identical material, but with a higher MFI of 200, needed 5 wt. % and preferably 7 wt. % polymer in the solution to give a similar morphology. We have found that optimal spinning solutions are those having polymer concentrations above about 1 wt. %, and preferably between about 3 wt. % to about 15 wt. %, with polyolefins having melt flow indices between about 1 to about 400 g/10 min. Concentrations that were much lower than this value did not produce nanofibers. Concentrations that were much greater than these values gave single-stranded yarns without nanofibers.

The spinneret orifice diameter affects the volumetric flow rate and the charge density. Large orifice diameters offer greater polymer throughputs and decreased probability of orifice plugging. Suitable orifice diameters are between about 0.125 mm to 1.25 mm, and even between about 0.25 mm to 1.25 mm.

The spinning temperature should be above the melting temperature of the polymer and above the solvent boiling point so as to effect evaporation of the solvent prior to deposition of polymer product on the collector, but not so high that the solvent volatilizes (boils) prior to the formation of nanofibers. A spinning temperature at least that of the solvent boiling point and at least that of the polymer melting point is suitable. A spinning temperature at least 40° C. greater than the solvent boiling point and at least 20° C. above the polymer melting point is advantageous. The spinning pressure of the present invention, measured just upstream of the spinneret, should be above the autogenous pressure of the solution, can range from about 1.8 to about 41 MPa and should be high enough to prevent the polymer solution from boiling.

Common additives, such as antioxidants, UV stabilizers, dyes, pigments, and other similar materials can be added to the spin composition prior to spinning.

### EXAMPLES

In the examples described below, the flash spinning equipment used was a modification of the apparatus described in U.S. Pat. No. 5,147,586. The apparatus comprised two high-pressure cylindrical chambers, each equipped with a piston adapted to apply pressure to the contents of the chamber. The cylinders had an inside diameter of 2.54 cm and each with an internal capacity of 50 cm³. The cylinders were connected to each other at one end through a 0.23 cm diameter channel and a mixing chamber containing a series of fine mesh screens that act as a static mixer. Mixing was accomplished by forcing the contents of the vessel back and forth between the two cylinders through the static mixer. The pistons were driven by high-pressure water supplied by a hydraulic system.

A spinneret assembly with a quick-acting means for opening the orifice was attached to the channel through a tee. The spinneret assembly comprised a lead hole of 12.8 mm diameter and 28.5 mm length. The spinneret orifice itself had a diameter of either 0.12 mm with length of 0.38 mm, or 0.25 mm with a length of 0.75 mm. The orifice flared with a 90 degree included angle to a diameter of 9.5 mm. An insulating polyphenylene sulfide electrode holder was placed within the lead hole of the spinneret. This holder had four channels for fluid flow equally spaced around its circumference. An emitter electrode was placed in the center of the holder. The electrode was attached at its upstream end to a high voltage wire, which entered the apparatus through a high-pressure sealing gland (Conax Inc, Buffalo, N.Y.). The voltage was supplied by a Spellman Inc. (Hauppauge, N.Y.) high voltage power supply. An analog current meter and a computer measured the supplied current. The spinneret assembly was electrically isolated from the rest of the apparatus by a polyphenylene sulfide insulating cup. An analog current meter and a computer measured the current to the second electrode. The electrical assembly of the type described here is known as a “Spray Triode” and is disclosed in U.S. Pat. No. 6,656,394.

The polymer of interest was charged into one cylinder. The indicated solvent was injected into that cylinder by a calibrated high pressure screw-type generator. The number of turns of the screw-type generator was calculated to give the desired concentration of the material in the solvent. High-pressure water was used to drive the pistons to generate a mixing pressure of between 13.8-27.6 MPa.

The polymer and solvent were then heated to the indicated temperature, as measured by a Type-J thermocouple (Technical Industrial Products Inc. of Cherry Hill, N.J.) and held at that temperature for about five minutes. The pressure of the spin mixture was reduced to between about 1.8 to about 5.3 MPa, just prior to spinning. This was accomplished by opening a valve between the spin cell and a much larger tank of high-pressure water (“the accumulator”) held at the desired spinning pressure. The spinneret orifice was opened as soon as possible (usually about one to two seconds) after the opening of the valve between the spin cell and the accumulator. The product was collected in an attached 76 cm×46 cm diameter polypropylene bucket. There was an aluminum covering on the downstream face of the bucket that was attached to an analog current meter, a resistor, and then ground. A computer monitored and logged the voltage across the resistor and then calculated the current flow to ground. The aluminum covering and inner walls of the bucket were covered with 0.12 mm-thick polyester sheet for ease of sample removal. The bucket was continuously purged with nitrogen at a rate of about 1400 cm³/s to exclude oxygen and thus, prevent ignition of flammable vapors. In some cases, a carbon steel bucket was used.

The pressure just before the spinneret was measured with a pressure transducer (Dynisco Inc. of Norwood, Mass.) and recorded during spinning and was referred to as “the spin pressure”. The spin pressure was recorded using a computer and was usually about 300 kPa below the accumulator pressure set point. The temperature measured just before the spinneret was also recorded during spinning and was referred to as “the spin temperature”. After spinning, the nanofiber-coated polyester sheet was removed from the bucket. Pieces were cut from the sheet and examined by scanning electron microscopy. Fiber surface areas per unit mass were also determined by the standard BET (Brunauer-Emmett-Teller) technique.

Table 1 below lists the polymers used in the following examples.

TABLE 1

| Polymer | | MFI | | Melting |
|---|---|---|---|---|
| Identi- | | (g/ | Density | Point |
| fication | Polymer | 10 min.) | (g/cc) | (° C.) |
| A | Engage ® 8407 (ethylene- | 30 | 0.87 | 60 |
| | octene copolymer) | | | |
| B | Engage ® Experimental 1 | 200 | 0.87 | 60 |
| | (ethylene-octene copolymer) | | | |
| C | Engage ® Experimental 2 | 1000 | 0.87 | 60 |
| | (ethylene-octene copolymer) | | | |
| D | Engage ® 8402 (ethylene- | 30 | 0.902 | 98 |
| | octene copolymer) | | | |
| E | Equistar XH4660 (HDPE) | 60 | 0.946 | — |
| F | Equistar Alathon ® H5050 | 50 | 0.950 | — |
| | (HDPE) | | | |
| G | Montell 89-6 (PP) | 1.43 | — | — |
| H | Aldrich 42, 789-6 (PP) | 35 | — | — |
| J | Basell Valtec ® HH441 (PP) | 400 | — | — |
| K | Dow Aspun ® 6811A (LLDPE) | 27 | 0.941 | 125 |
| L | Lyondell 31S12V XO212 (PP) | 10.4 | — | — |

### Comparative Example 1

A solution of 3 wt. % Polymer A in Freon®-11 was prepared, supplied to the apparatus of FIG. 3 at a spin temperature of 103° C. and flash spun through a spin orifice having a diameter of 0.25 mm at a pressure of 2.7 MPa and a flow rate of 2.67 cm³/s. No voltage was applied to the system. No nanofibers were formed as shown in FIG. 7.

### Example 1

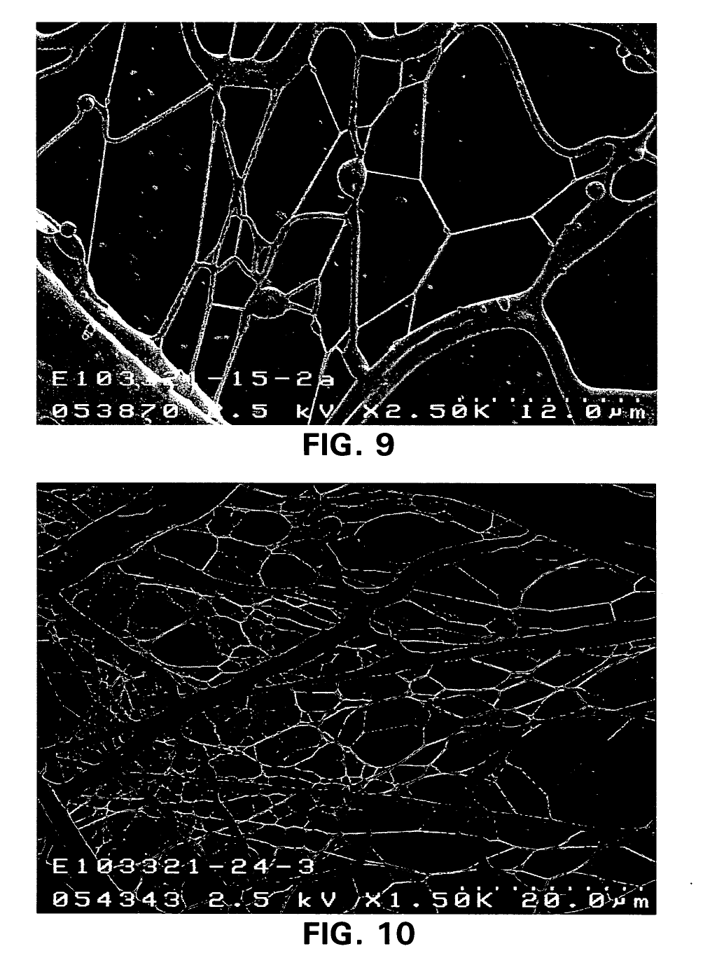

The polymer solution and parameters of Comparative Example 1 were repeated, except that the spinning temperature was 100° C., the pressure was 2.9 MPa and the flow rate was 2.4 cm³/s and a voltage of 16 kV was applied to the emitter electrode. The resulting product was characterized by an interconnecting complex web of larger filaments which were further interconnected by complex webs of filaments having sub-micron widths as shown in FIGS. 8 and 9.

### Example 2

A solution of 7 wt. % Polymer B in Freon®-11 was prepared, supplied to the apparatus of FIG. 3 at a spin temperature of 105° C. and flash spun through a spin orifice having a diameter of 0.25 mm at a pressure of 2.5 MPa and a flow rate of 2.52 cm³/s. A voltage of 16 kV was applied to the emitter electrode. The resulting product is shown in FIG. 10.

### Example 3

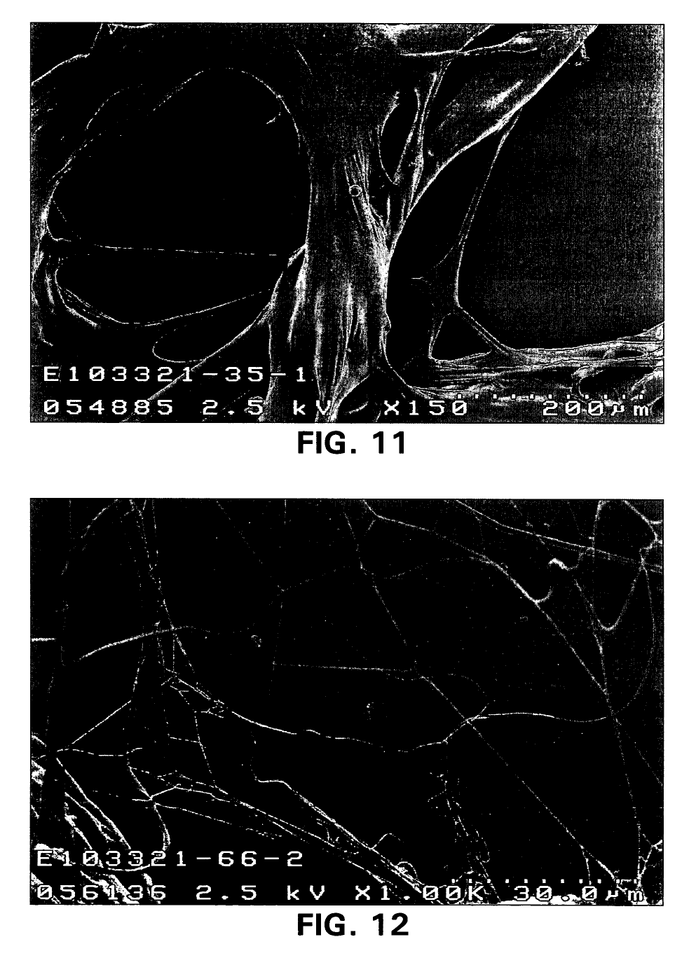

A solution of 18 wt. % Polymer C in Freon®-11 was prepared, supplied to the apparatus of FIG. 3 at a spin temperature of 101° C. and flash spun through a spin orifice having a diameter of 0.25 mm at a pressure of 2.5 MPa and a flow rate of 2.49 cm³/s. A voltage of 14 kV was applied to the emitter electrode. The resulting product had no nanofibers and is shown in FIG. 11.

### Example 4

A solution of 9 wt. % Polymer D in hexane was prepared, supplied to the apparatus of FIG. 3 at a spin temperature of 140° C. and flash spun through a spin orifice having a diameter of 0.25 mm at a pressure of 2.9 MPa and a flow rate of 3.73 cm³/s. A voltage of 14 kV was applied to the emitter electrode. The resulting product is shown in FIG. 12.

### Example 5

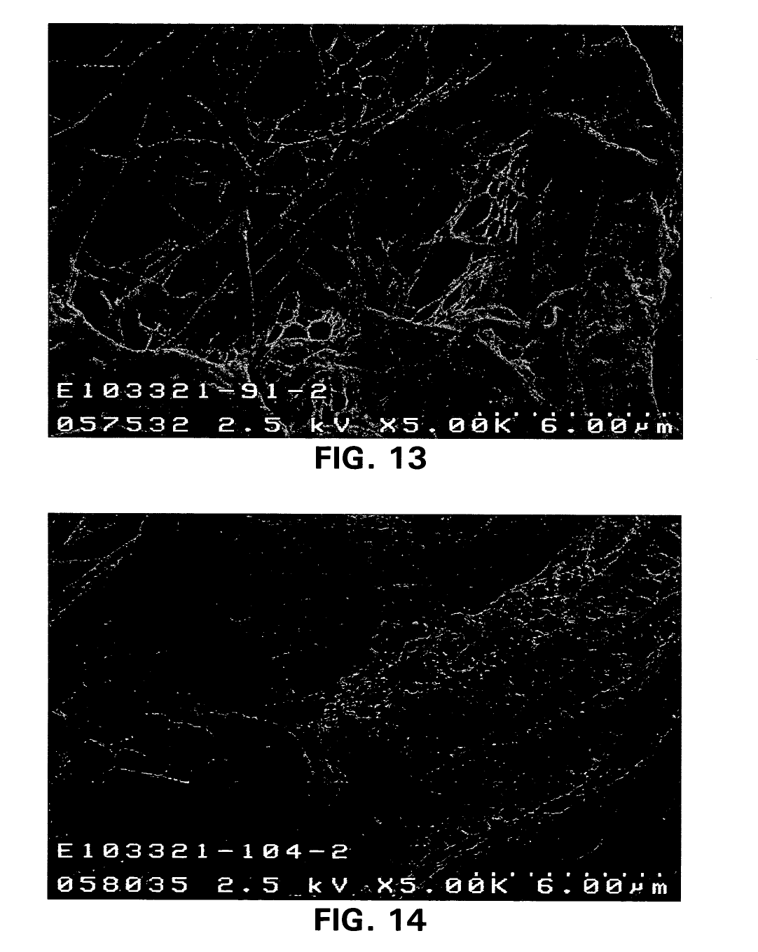

A solution of 6 wt. % Polymer E in heptane was prepared, supplied to the apparatus of FIG. 3 at a spin temperature of 180° C. and flash spun through a spin orifice having a diameter of 0.125 mm at a pressure of 4.9 MPa and a flow rate of 1.06 cm³/s. A voltage of 12 kV was applied to the emitter electrode. The resulting product is shown in FIG. 13.

### Example 6

A solution of 8 wt. % of a 90/10 w/w blend of Polymers F and G in heptane was prepared, supplied to the apparatus of FIG. 3 at a spin temperature of 181° C. and flash spun through a spin orifice having a diameter of 0.125 mm at a pressure of 5.0 MPa and a flow rate of 1.1 cm³/s. A voltage of 11.8 kV was applied to the emitter electrode. The resulting product is shown in FIG. 14.

### Example 7

A solution of 2.5 wt. % Polymer G in octane was prepared, supplied to the apparatus of FIG. 3 at a spin temperature of 211° C. and flash spun through a spin orifice having a diameter of 0.25 mm at a pressure of 1.9 MPa and a flow rate of 2.82 cm³/s. A voltage of 13.1 kV was applied to the emitter electrode. The resulting product is shown in FIG. 15.

### Example 8

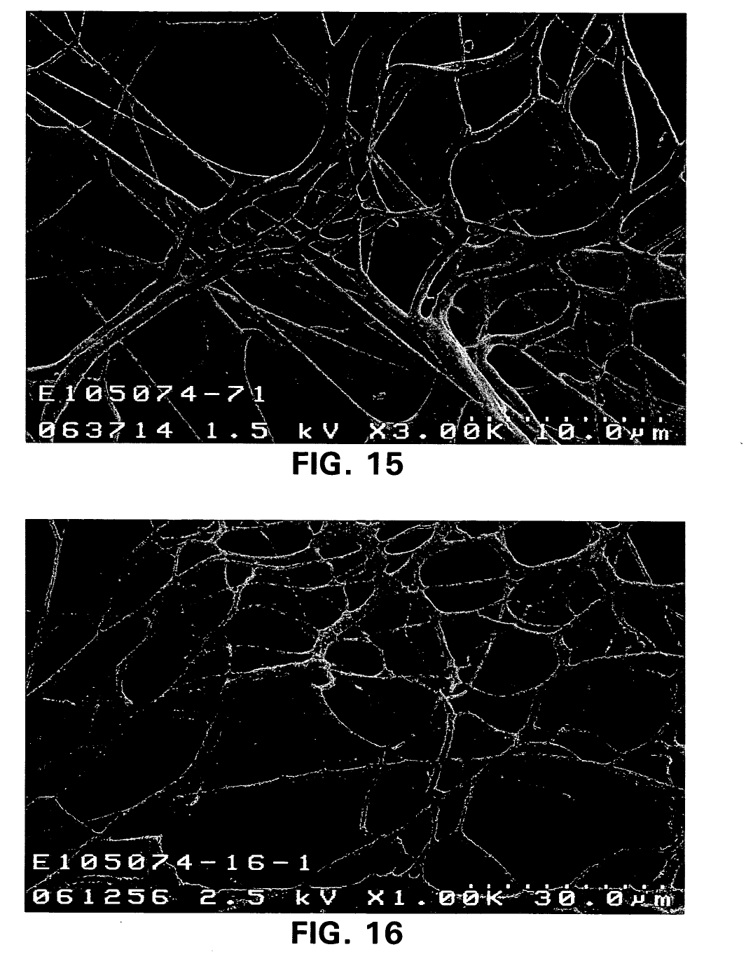

A solution of 12 wt. % Polymer J in octane was prepared, supplied to the apparatus of FIG. 3 at a spin temperature of 210° C. and flash spun through a spin orifice having a diameter of 0.25 mm at a pressure of 5.2 MPa and a flow rate of 4.42 cm³/s. A voltage of 13.1 kV was applied to the emitter electrode. The resulting product is shown in FIG. 16.

### Example 9

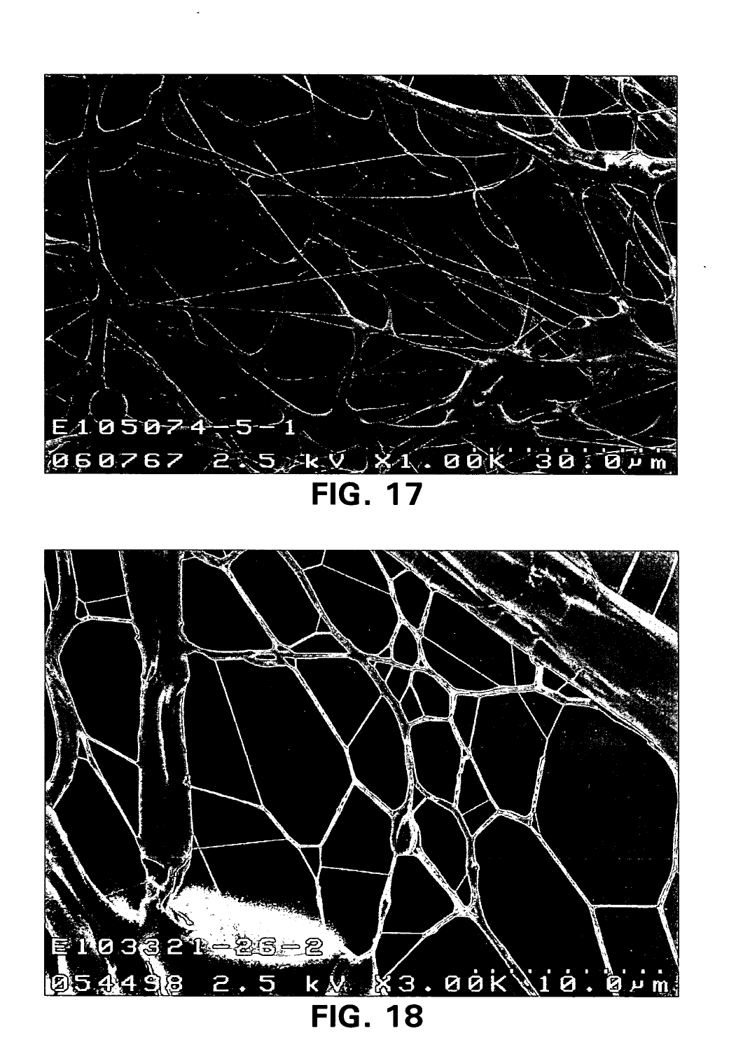

A solution of 8 wt. % Polymer H in octane was prepared, supplied to the apparatus of FIG. 3 at a spin temperature of 182° C. and flash spun through a spin orifice having a diameter of 0.125 mm at a pressure of 5.2 MPa and a flow rate of 1.25 cm³/s. A voltage of 13.7 kV was applied to the emitter electrode. The resulting product is shown in FIG. 17.

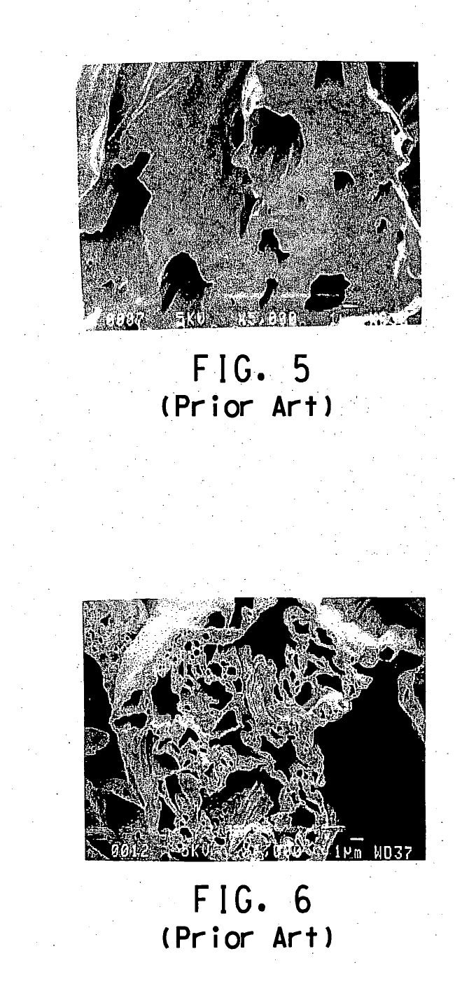

Comparison of FIGS. 8-10 and 12-17, from the Examples above, reveal that the process of the present invention is successful in producing flash spun nonwoven structures containing a majority of filaments having sub-micron widths, in contrast to conventionally flash spun Tyvek®, FIGS. 5 and 6, which shows few if any filaments having sub-micron widths.

### Examples 10-17

In the following examples the indicated polymers were flash spun with charge injection under the indicated conditions, SEM images were taken and the SEM images were analyzed with an image analysis technique using KHOROS PRO 200 software (UNIX version), available from KHORAL, Inc. of Albuquerque, N. Mex. The image analyses provided quantitative data as to (1) web voids size distribution—diameter equivalents, (2) web voids size distribution—long axis, and (3) web fiber width distribution. Data as to web voids shape distribution by aspect ratio was also obtained.

The measurement of web voids size as diameter equivalents (Deq) was determined by measurement of the area of the voids or pores within the nonwoven fibrous structure, which are irregular in shape, then converting those areas to diameters of circles of equivalent area. Thus, the area of the irregular-shaped pores is divided by pi (π), and the square root of the resulting number is doubled to obtain an equivalent circular diameter.

The measurement of web voids size by long axis is obtained by measuring the longest distance within the voids or pores, which are approximately elliptical in shape.

The web fiber width was measured as the pixel width of the image of each fiber or filament, and converted to a corresponding width in nanometers or micrometers.

Each of the measurements above was summed over the SEM image and a conventional statistical analysis was run to provide minima, maxima and means of the distributions.

### Example 10

A solution of 7 wt. % Polymer B in Freon®-11 was prepared, supplied to the apparatus of FIG. 3 at a spin temperature of 100° C. and flash spun through a spin orifice having a diameter of 0.25 mm at a pressure of 2.5 MPa and a flow rate of 2.54 cm³/s. A voltage of 16 kV was applied to the emitter electrode. The resulting product is shown in FIG. 18.

### Example 11

A solution of 7 wt. % Polymer B in Freon®-11 was prepared, supplied to the apparatus of FIG. 3 at a spin temperature of 100° C. and flash spun through a spin orifice having a diameter of 0.25 mm at a pressure of 2.0 MPa and a flow rate of 2.44 cm³/s. A voltage of 16 kV was applied to the emitter electrode. The resulting product is shown in FIG. 19.

### Example 12

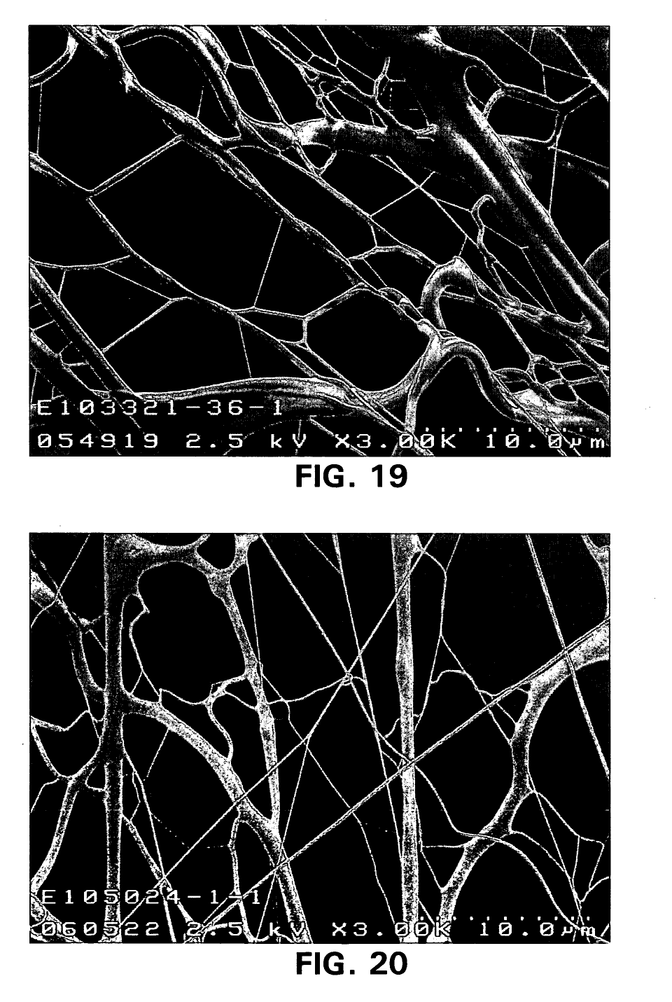

A solution of 5.5 wt. % Polymer L in octane was prepared, supplied to the apparatus of FIG. 3 at a spin temperature of 200° C. and flash spun through a spin orifice having a diameter of 0.125 mm at a pressure of 4.9 MPa and a flow rate of 1.22 cm³/s. A voltage of 13.7 kV was applied to the emitter electrode. The resulting product is shown in FIG. 20.

### Example 13

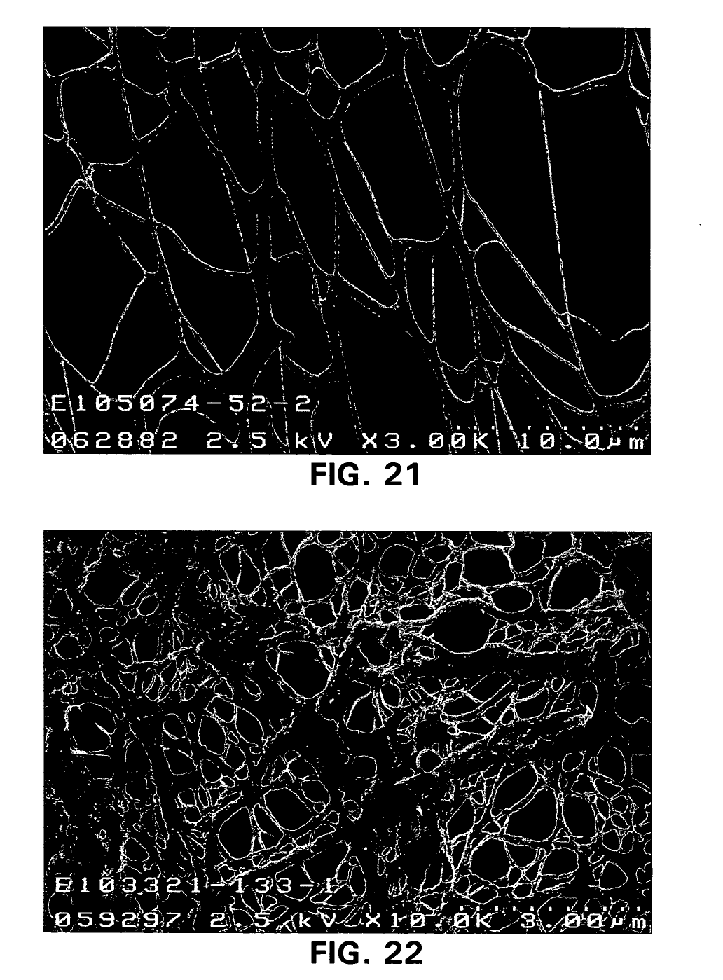

A solution of 6 wt. % Polymer H in octane was prepared, supplied to the apparatus of FIG. 3 at a spin temperature of 190° C. and flash spun through a slot die having a width of 0.25 mm and a length of 0.88 mm at a pressure of 1.9 MPa and a flow rate of 11.9 cm³/s. A voltage of 16.4 kV was applied to the emitter electrode. The resulting product is shown in FIG. 21.

### Example 14

A solution of 8 wt. % Polymer F in a mixed solvent of heptane/pentane (50v/50v) was prepared, supplied to the apparatus of FIG. 3 at a spin temperature of 192° C. and flash spun through a spin orifice having a diameter of 0.125 mm at a pressure of 5.0 MPa and a flow rate of 1.11 cm³/s. A voltage of 12.1 kV was applied to the emitter electrode. The resulting product is shown in FIG. 22.

### Example 15

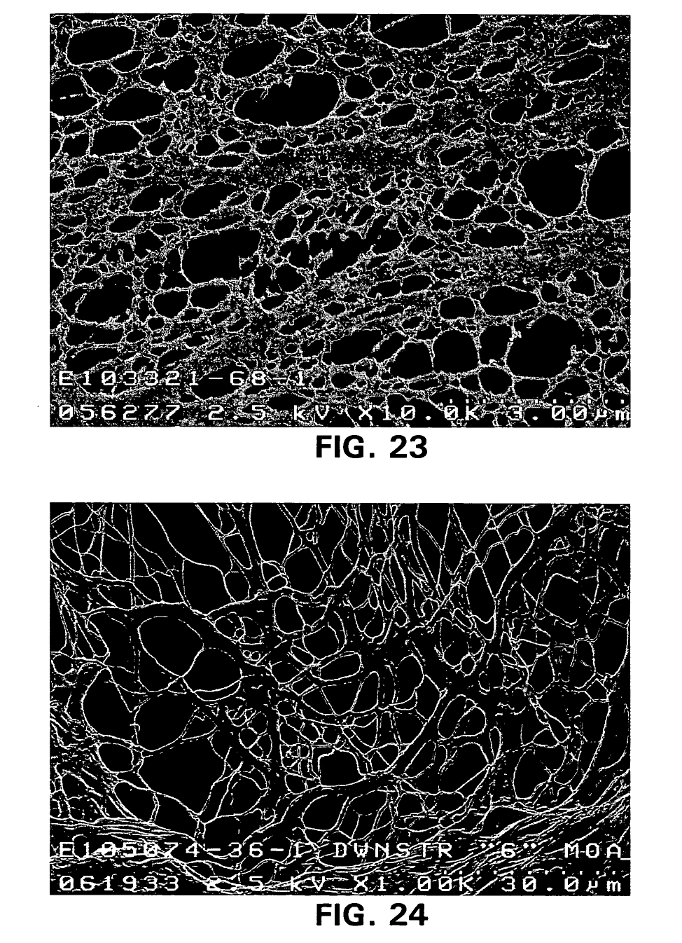

A solution of 5 wt. % Polymer K in hexane was prepared, supplied to the apparatus of FIG. 3 at a spin temperature of 141° C. and flash spun through a spin orifice having a diameter of 0.125 mm at a pressure of 2.3 MPa and a flow rate of 3.59 cm³/s. A voltage of 14 kV was applied to the emitter electrode. The resulting product is shown in FIG. 23.

### Example 16

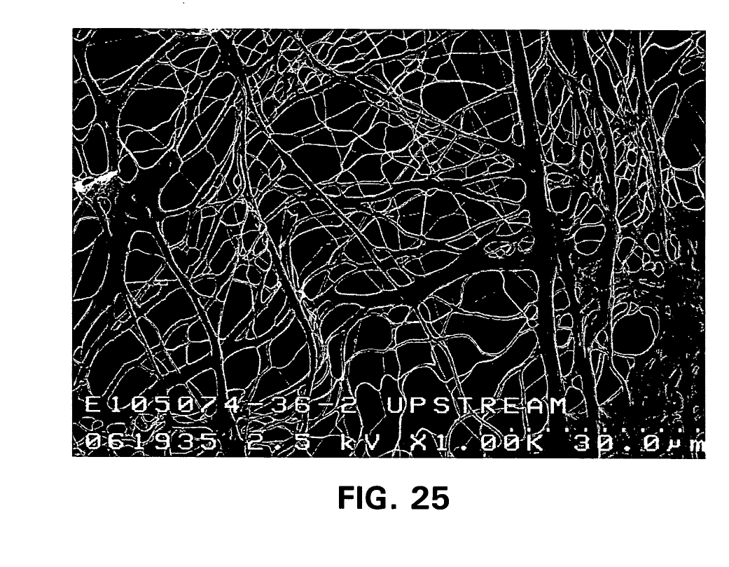

A solution of 6 wt. % Polymer H in octane was prepared, supplied to the apparatus of FIG. 3 at a spin temperature of 21° C. and flash spun through a spin orifice having a diameter of 0.25 mm at a pressure of 5.0 MPa and a flow rate of 4.49 cm³/s. A voltage of 16.4 kV was applied to the emitter electrode. The resulting product is shown in FIG. 24.

### Example 17

A sample of product of Example 16 was taken from a different position in the collection bucket, a SEM image was taken and an image analysis was performed. The resulting product is shown in FIG. 25.

The results of the image analyses conducted on samples 10-17 are reported below in Table 2.

TABLE 2

| | Mean | | Max. Void Size | Mean Fiber |
|---|---|---|---|---|
| | Void Size | Mean Void Size | (Long | Width |
| Example | (Deq μm) | (Long Axis μm) | Axis μm) | (μm) |
| 10 | 1.95 | 2.98 | 10.6 | 0.68 |
| 11 | 2.10 | 3.56 | 12.8 | 1.06 |
| 12 | 1.86 | 3.18 | 9.9 | 0.49 |
| 13 | 2.48 | 4.19 | 14.7 | 0.50 |
| 14 | 0.20 | 0.28 | 1.4 | 0.29 |
| 15 | 0.23 | 0.33 | 1.8 | 0.18 |
| 16 | 2.08 | 3.31 | 19.2 | 0.30 |
| 17 | 1.69 | 2.69 | 13.1 | 0.29 |

The image analysis data presented in Table 2 reveals that the process of the present invention formed nonwoven polyolefin structures having a mathematical mean of fiber or filament width distributions between about 0.18 and about 1 micrometer, even between about 0.18 and about 0.7 micrometer, or even between about 0.18 and about 0.5 micrometer, or even between about 0.18 and about 0.3 micrometer, and a mathematical mean of void or pore size distributions from about 0.20 to about 2.5 micrometer, even between about 0.20 to about 2 micrometers, or even between about 0.20 to about 1.8 micrometers. The maximum void size, as measured by the long axis, was about 20 micrometers, even less than about 15 micrometers, and even as small as between about 1 micrometer to about 15 micrometers, and the mathematical mean of the long axis void sizes was less than about 5 micrometers, and even as low as between about 0.25 micrometer to about 4 micrometers.

The nonwoven fibrous structures of the present invention may find use in the manufacture of sheet structures for protective apparel, fluid filters and the like. It may be advantageous to deposit the inventive nonwoven fibrous structures onto a supporting scrim of other conventional fabrics, such as spunbond fabrics, melt blown fabrics, spunlaced fabrics, woven fabrics or the like.

We claim:

1. A nonwoven fibrous structure comprising an interconnecting web of polyolefin filaments having filament widths greater than about 1 micrometer which are further interconnected with webs of smaller polyolefin filaments having filament widths less than about 1 micrometer, wherein said smaller polyolefin filaments comprise a majority of all filaments.

2. The nonwoven, fibrous structure of claim 1, comprising smaller polyolefin filaments having widths less than 0.5 micrometer.

3. The nonwoven fibrous structure of claim 1, wherein the smaller polyolefin filaments have widths in the range from about 0.1 micrometer to about 0.8 micrometer.

4. The nonwoven fibrous structure of claim 1, wherein the polyolefin is selected from the group of linear low density polyethylene, high density polyethylene, low density polyethylene, polymethylpentene, polypropylene, ethylene-C₃ to C₁₀ α-olefin copolymers, propylene-ethylene copolymers and blends thereof.

5. The nonwoven fibrous structure of claim 4, wherein the polyolefin is linear low density polyethylene.

6. The nonwoven fibrous structure of claim 4, wherein the polyolefin is high density polyethylene.

7. The nonwoven fibrous structure of claim 4, wherein the polyolefin is polypropylene.

8. The nonwoven fibrous structure of claim 4, wherein the polyolefin is a blend of high density polyethylene and polypropylene.

9. The nonwoven fibrous structure of claim 1, which is deposited on a supporting scrim.

10. The nonwoven fibrous structure of claim 4, wherein the polyolefin is an ethylene-C₃ to C₁₀ α-olefin copolymer selected from the group consisting of ethylene-octene copolymer, ethylene-propylene copolymer and ethylene-butene copolymer.

11. The nonwoven fibrous structure of claim 1, further comprising pores formed within the interconnected webs of smaller polyolefin filaments, having a pore size diameter equivalent distribution of between about 0.20 to about 2.5 micrometers.

12. The nonwoven fibrous structure of claim 11, wherein the smaller polyolefin filaments have lengths of the same order of magnitude as the diameters of the pores.

13. A method of producing a nonwoven fibrous structure having a majority of filaments with filament widths less than about 1 micrometer, comprising:
supplying a polyolefin solution at above-ambient temperature and pressure to a spinneret;
contacting said polyolefin solution with a first electrode disposed within said spinneret, said electrode being charged to a high voltage potential relative to a collection surface, so as to impart an electrical charge to said polyolefin solution;
issuing said charged polyolefin solution through a spinneret exit orifice which incorporates a second electrode held at less than the voltage potential of said first electrode, to form polyolefin filaments; and
collecting said polyolefin filaments on said collection surface to form an interconnecting web of polyolefin filaments having filament widths greater than about 1 micrometer which are further interconnected with webs of smaller polyolefin filaments having filament widths less than about 1 micrometer, wherein said smaller polyolefin filaments comprise a majority of all filaments.

14. The method of claim 13, wherein said polyolefin solution is heated to a temperature at least about 20° C. above the melting point of the polymer.

15. The method of claim 14, wherein the pressure is sufficient to prevent the polymer solution from boiling.

16. The method of claim 15, wherein the polyolefin solution has a low enough conductivity to maintain the potential voltage difference between said first and second electrodes.

17. The method of claim 16, wherein the potential voltage difference between the first and second electrodes is at least 3 kilovolts.

18. The method of claim 13, wherein the voltage potential between the first electrode and said collection surface is at least a 3 kilovolts.

19. The method of claim 13, wherein the polymer solution comprises at least about 1 wt. % polyolefin.

20. The method of claim 19, wherein the polymer solution comprises at least about 3 wt. % to about 15 wt. % polyolefin.

21. The method of claim 13, wherein the polyolefin solution is charged to a charge density between about 0.4 to about 3 microCoulombs/mL.

22. The method of claim 13, wherein said charged polyolefin solution is issued through the spinneret exit orifice at a flow rate between about 1 to about 20 cm³/sec.

23. The method of claim 13, wherein said charged polyolefin solution is issued through the spinneret exit orifice at a pressure between about 1.8 to about 41 Mpa.

24. A nonwoven fibrous structure comprising a collection of filaments formed from a polyolefin composition wherein the mean of the filament widths is less than about 1 micrometer and the maximum of the filament widths is greater than about 1 micrometer.

25. The nonwoven fibrous structure of claim 23, wherein the mean of the filament widths is less than about 0.5 micrometer.

26. The nonwoven fibrous structure of claim 23, wherein the mean of the filament widths is less than about 0.3 micrometer.

27. The nonwoven fibrous structure of claim 23, wherein the polyolefin composition is selected from the group of linear low density polyethylene, high density polyethylene, low density polyethylene, polymethylpentene, polypropylene, ethylene- C₃ to C₁₀ α-olefin copolymers, propylene-ethylene copolymers and blends thereof.

28. The nonwoven fibrous structure of claim 23, wherein the filaments are all formed from the same polyolefin composition.

29. The nonwoven fibrous structure of claim 23, wherein the filaments having widths less than about 1 micrometer have lengths of less than about 10 micrometer.

30. A nonwoven fibrous structure comprising a collection of filaments formed from a polyolefin composition comprising a collection of polyolefin filaments wherein the mean of the filament widths is less than about 1 micrometer, and pores formed between said polyolefin filaments, said nonwoven fibrous structure exhibiting a pore size diameter equivalent distribution of between about 0.20 to about 2.5 micrometers.

31. The nonwoven fibrous structure of claim 29, wherein the polyolefin filaments having widths less than about 1 micrometer have lengths of the same order of magnitude as the diameters of the pores.

32. The nonwoven fibrous structure of claim 30, wherein the filaments having widths less than about 1 micrometer have lengths of less than about 10 micrometer.

33. The nonwoven fibrous structure of claim 29, wherein said fibrous structure exhibits maximum long axis pore sizes less than about 15 micrometers.
